(19) United States
(12) Patent Application Publication
(10) Pub. No.: US 2020/0302350 A1
(43) Pub. Date: Sep. 24, 2020

(54) NATURAL LANGUAGE PROCESSING BASED BUSINESS DOMAIN MODELING

(71) Applicant: INTERNATIONAL BUSINESS MACHINES CORPORATION, ARMONK, NY (US)

(72) Inventors: Teng Sun, Beijing (CN); Ying Wei, Ningbo (CN); Ting Yao Liu, Ningbo (CN); Yuan Li, Ningbo (CN); Qiang He, Ningbo (CN)

(21) Appl. No.: 16/356,643

(22) Filed: Mar. 18, 2019

(51) Int. Cl. G06Q 10/06; G06Q 50/00; G06F 17/27

(52) U.S. Cl. CPC G06Q 10/067; G06F 17/2705; G06Q 50/01

(57) ABSTRACT

A method, computer system, and computer program product for NLP-based domain modeling are provided. The embodiment may include receiving, by a processor, a plurality of documents related to business requirements. The embodiment may also include parsing the received documents to extract business concepts based on sentence analysis utilizing an NLP technology. The embodiment may further include generating domain models based on the extracted business concepts. The embodiment may also include clustering the generated domain models into specific domains.

### BACKGROUND

The present invention relates, generally, to the field of computing, and more particularly to microservices domain modeling.

Microservices is an implementation approach for service-oriented architectures used to build flexible, independently deployable software systems. It structures an application as a collection of loosely coupled services. By decomposing an application into different smaller services, it can improve modularity and flexibility and allow small teams of software engineers to develop software autonomously and deploy the services independently. A domain model is a system of abstraction that describes meaningful real-world concepts pertinent to a particular domain that need to be modeled in software. For example, in ontology engineering, a domain model is used to represent a knowledge domain with concepts, roles, datatypes, individuals, and rules.

### SUMMARY

According to one embodiment, a method, computer system, and computer program product for NLP-based domain modeling are provided. The embodiment may include receiving, by a processor, a plurality of documents related to business requirements. The embodiment may also include parsing the received documents to extract business concepts based on sentence analysis utilizing an NLP technology. The embodiment may further include generating domain models based on the extracted business concepts. The embodiment may also include clustering the generated domain models into specific domains.

### BRIEF DESCRIPTION OF THE SEVERAL VIEWS OF THE DRAWINGS

These and other objects, features, and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating a Natural Language Processing (NLP) based business domain modeling process according to at least one embodiment;

FIG. 3 is a block diagram of an NLP-based business domain modeling platform according to at least one embodiment;

FIG. 4 is a block diagram showing an exemplary requirement analysis process using an NLP-based business domain modeling operation according to at least one embodiment;

FIG. 5 is a block diagram showing an exemplary domain model building process using an NLP-based business domain modeling operation according to at least one embodiment;

FIG. 6 is a block diagram showing an exemplary model refine and clustering process using an NLP-based business domain modeling operation according to at least one embodiment;

FIG. 7 is a block diagram of internal and external components of computers and servers depicted in FIG. 1 according to at least one embodiment;

FIG. 8 depicts a cloud computing environment according to an embodiment of the present invention; and

FIG. 9 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to microservices domain modeling. The following described exemplary embodiments provide a system, method, and program product to analyze received documents using an NLP technology and extract core business concepts to set up relationships and identify domain models. Therefore, the present embodiment has the capacity to improve the technical field of microservices domain modeling system by analyzing potential domains from business requirements and establish relationships between business domain concepts more accurately and more quickly as embodiments of the invention may process the business requirements documents and generate domain models automatically without human interactions.

As previously described, microservices is an implementation approach for service-oriented architectures used to build flexible, independently deployable software systems. It structures an application as a collection of loosely coupled services. By decomposing an application into different smaller services, it can improve modularity and flexibility and allow small teams of software engineers to develop software autonomously and deploy the services independently. A domain model is a system of abstraction that describes meaningful real-world concepts pertinent to a particular domain that need to be modeled in software. For example, in ontology engineering, a domain model is used to represent a knowledge domain with concepts, roles, datatypes, individuals, and rules.

Building a business solution model usually starts from business requirements, then transforms those requirements into domain models, and finally turns them into an architecture overview as a basis for further software development. As microservices is becoming a very popular architecture approach, more and more systems and solutions are built in this way. However, it may be quite time-consuming for tasks to analyze business requirements and draft clear domain models. As such, it may be advantageous to, among other things, implement a system capable of analyzing potential domains from business requirements and establish relationships between business domain concepts more accurately and quickly.

According to one embodiment, an NLP-based business domain modeling system may utilize an NLP technology to parse received documents and extracted core business concepts based on sentence analysis. In at least one other embodiment, the NLP-based business domain modeling system may identify domain models based on parsed document data, set up relationships between models and attach relevant attributes. According to other embodiment, the NLP-based business domain modeling system may analyze potential business domains based on model linkages and generalize the domains using knowledge data.

The present invention may be a system, a method, and/or a computer program product at any possible technical detail level of integration. The computer program product may include the computer readable storage medium (or media) having computer readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer-readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or another device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product for accelerating microservices domain modeling by analyzing business requirements, building domain models and clustering and refining those models.

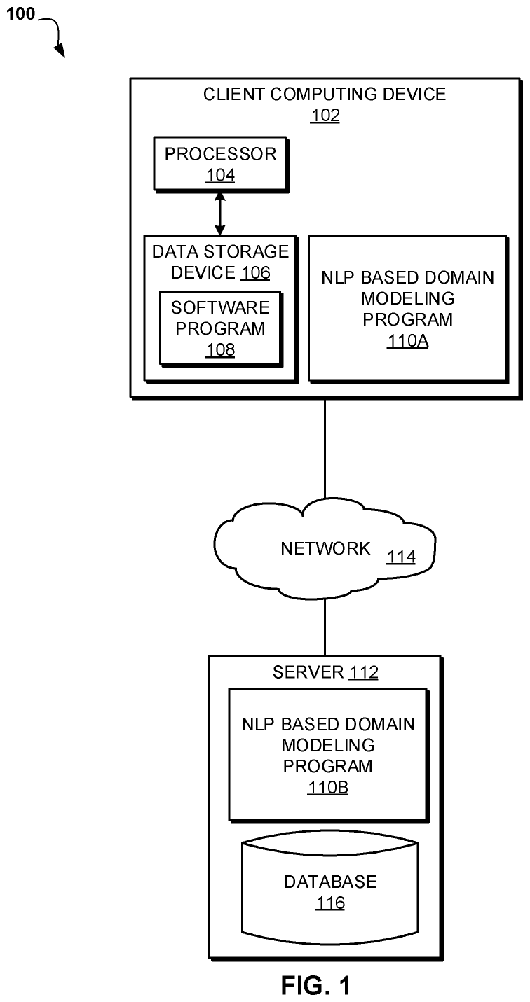

Referring to FIG. 1, an exemplary networked computer environment 100 is depicted, according to at least one embodiment. The networked computer environment 100 may include client computing device 102 and a server 112 interconnected via a communication network 114. According to at least one implementation, the networked computer environment 100 may include a plurality of client computing devices 102 and servers 112 of which only one of each is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

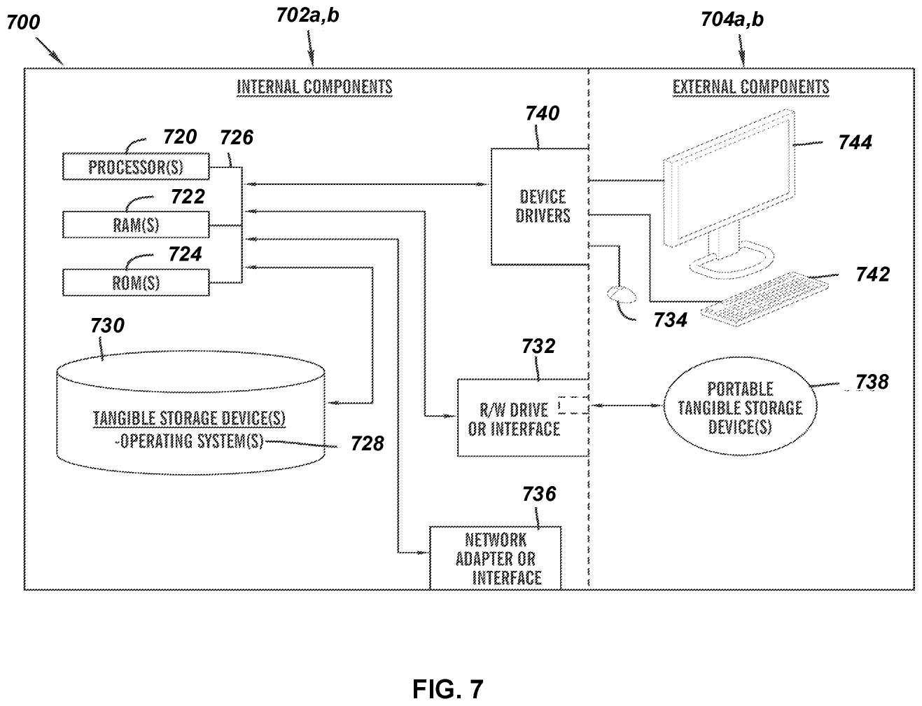

Client computing device 102 may include a processor 104 and a data storage device 106 that is enabled to host and run a software program 108 and an NLP-based domain modeling program 110A and communicate with the server 112 via the communication network 114, in accordance with one embodiment of the invention. Client computing device 102 may be, for example, a mobile device, a telephone, a personal digital assistant, a netbook, a laptop computer, a tablet computer, a desktop computer, or any type of computing device capable of running a program and accessing a network. As will be discussed with reference to FIG. 7, the client computing device 102 may include internal components 702a and external components 704a, respectively.

The server computer 112 may be a laptop computer, netbook computer, personal computer (PC), a desktop computer, or any programmable electronic device or any network of programmable electronic devices capable of hosting and running an NLP-based domain modeling program 110B and a database 116 and communicating with the client computing device 102 via the communication network 114, in accordance with embodiments of the invention. As will be discussed with reference to FIG. 7, the server computer 112 may include internal components 702b and external components 704b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

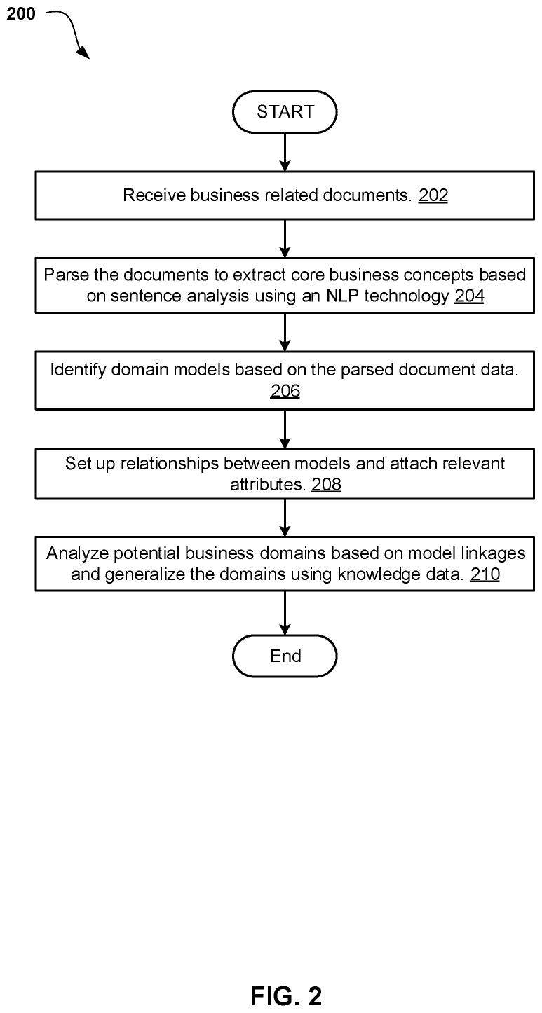

According to the present embodiment, the NLP-based domain modeling program 110A, 110B may be a program capable of parsing received business-related documents to extract core business requirements based on sentence analysis utilizing an NLP technology. The NLP-based domain modeling program 110A, 110B may also determine relationships between identified domain models. The NLP-based domain modeling program 110A, 110B may further cluster and refine the identified business domains using knowledge data. The NLP-based domain modeling process is explained in further detail below with respect to FIG. 2.

FIG. 2 is an operational flowchart illustrating an NLP-based domain modeling process 200 according to at least one embodiment. At 202, the NLP-based domain modeling program 110A, 110B receives business-related documents. According to one embodiment, the NLP-based domain modeling program 110A, 110B may retrieve business-related documents from a database 116. Business-related documents may include service reviews, reports, industry insights, business analysis, business process, role and responsibilities, etc. According to at least one other embodiment, the NLP-based domain modeling program 110A, 110B may receive business-related documents, such as customer complaints, comments or related news from social media sites. Further, the NLP-based domain modeling program 110A, 110B may enable users to manually upload business-related documents to a server 112.

At 204, the NLP-based domain modeling program 110A, 110B parses the received documents to extract core business concepts based on sentence analysis using an NLP technology. According to one embodiment, the NLP-based domain modeling program 110A, 110B may analyze the received documents and find pre-configured keywords in documents texts. For example, the NLP-based domain modeling program 110A, 110B may receive certain documents which contains customer feedback regarding a service provider's work quality, timeliness and price, and find pre-configured keywords or relevant terms, such as “price”, “expensive”, “cheap”, “good quality” “bad quality”, etc. from a given corpus. Business concepts may further include key terminology or concepts that frequently appear in the parsed documents. For example, with respect to hotel management, business requirements may include customer rating, comments, star rating, price range, availability of rooms, cleanness of rooms and those terms or concepts may be found frequently in the parsed document.

At 206, the NLP-based domain modeling program 110A, 110B identifies domain models based on the parsed document data. According to one embodiment, the NLP-based domain modeling program 110A, 110B may determine whether each concept or keyword extracted from the parsed document is required or needed to build a model. For example, if the NLP-based domain modeling program 110A, 110B extracts key concepts, such as a number of website visits, average dollar amounts spent per visit, user comments, feedback on a scale of 1 to 10, etc., the NLP-based domain modeling program 110A, 110B may then select relevant concepts from the list of the extracted concepts. According to at least one other embodiment, the NLP-based domain modeling program 110A, 110B may determine the relevancy of each of the extracted concepts based on a pre-configured key terminology or concept or manual user input. For example, the NLP-based domain modeling program 110A, 110B may select feedback on a scale of 1 to 10 as a relevant concept to build a model, but the NLP-based domain modeling program 110A, 110B may determine that comment numbers are not relevant.

At 208, the NLP-based domain modeling program 110A, 110B sets up relationships between models and attaches relevant attributes. According to one embodiment, the NLP-based domain modeling program 110A, 110B may determine relationships and connect each model that was selected in step 206. For example, the NLP-based domain modeling program 110A, 110B may determine the main model that may have relationships with all other models and connect the main model with the other models. Each of the other models may have a plurality of similar models. If the NLP-based domain modeling program 110A, 110B determines that “restaurant” is the main model that connects to other models which may be “ratings”, “comments”, and “dollars spent by customers”. The models, “ratings”, “comments” and “dollars spent by customers” may have multiple similar models as each rating or comment, for example, may have various different data received from different individuals. In at least one other embodiment, the NLP-based domain modeling program 110A, 110B may attach and fill each model with attributes. For example, the NLP-based domain modeling program 110A, 110B may attach attributes, such as “location”, “average price”, “customer ratings” to the model “Restaurant”. Likewise, the NLP-based domain modeling program 110A, 110B may attach relevant attributes determined from the parsed business documents to all other linked models.

At 210, the NLP-based domain modeling program 110A, 110B analyzes potential business domains based on model linkages and generalize the domains using knowledge data. According to one embodiment, the NLP-based domain modeling program 110A, 110B may refine and cluster the created models and relationships into domains with reference from specific domain knowledge data and models. In at least one other embodiment, the NLP-based domain modeling program 110A, 110B may receive knowledge data from a database. The database may include a product domain knowledge and reference model database and an evaluation domain knowledge and reference model database. The domain knowledge may include domain-specific data, usually stored in knowledge graph format. The reference model data may include model data, usually stored in uml/xml format. Both types of data may be retrieved using keyword search and mapping or rating approach. For example, once the NLP-based domain modeling program 110A, 110B created relevant models and determined relationships between the models, the NLP-based domain modeling program 110A, 110B may then proceed to determine which product domain and evaluation domain are relevant to the created domain model and cluster the created domain model into the determined product domain and evaluation domain.

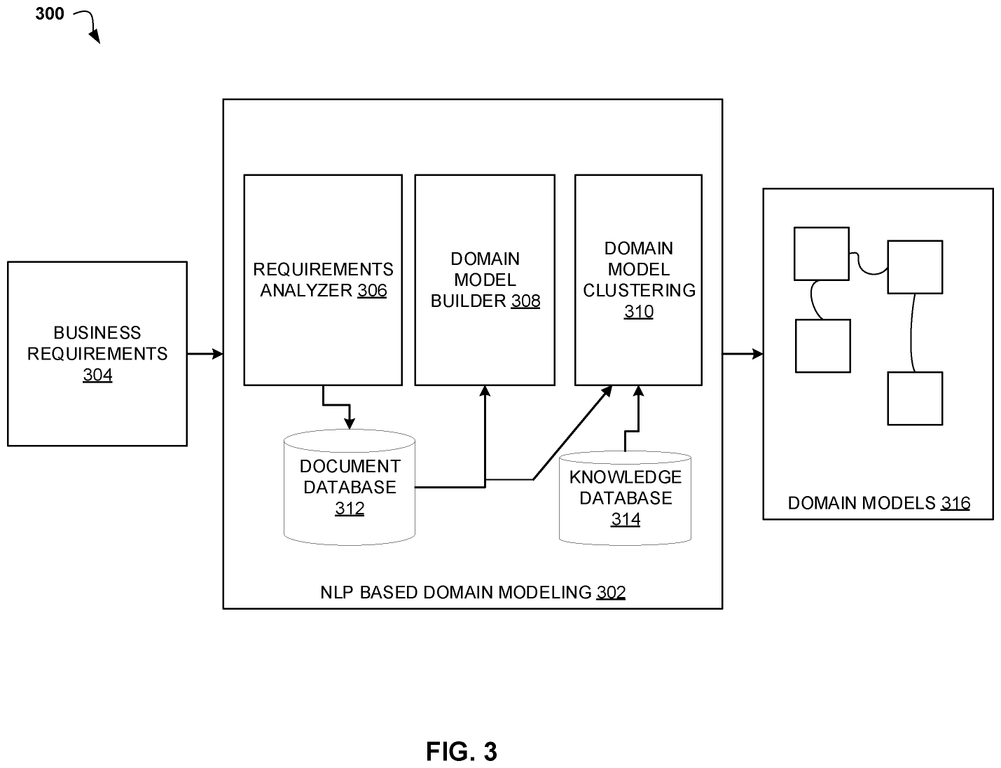

Referring now to FIG. 3, a block diagram of an NLP-based business domain modeling platform 300 is depicted according to at least one embodiment. According to one embodiment, an NLP-based domain modeling 302 comprises a requirement analyzer 306, a document model builder 308, and a domain model clustering 310. The requirement analyzer 306 may receive business requirements 304. The requirement analyzer 306 may then utilize an NLP technology to analyze sentences and identify subject-verb-object structures from the received business requirements 304. The business requirements 304 may be business related documents or data that can be retrieved from a database, social media sites or user-uploaded documents. The requirement analyzer 306 may also extract key concepts from the analyzed sentences and link attributes to the extracted key concepts. The requirement analyzer 306 may save the identified subject-verb-object structures and extracted key concepts linked to the original sentences in the documents to a document database 312. The domain model builder 308 may transform the key concepts into models and remove the invalid ones. For example, if words contained in a key concept model is determined to be too specific or unique based on a tf-idf analysis, the domain model builder 308 may discard and exclude the particular concept model from a domain model. The tf-idf analysis may be based on the documents or analysis summary saved in the document database 312. The domain model clustering 310 may reference from specific domain knowledge data and models saved in a knowledge database 314 and the document database 312 to generalize the models and cluster them into domain models 316 based on the models and the relationships generated by the domain model builder 308. The NLP-based domain model 302 may, for example, cluster the generated models into domains such as “product domain”, “evaluation domain” and “improvement/solution domain”, etc., so that each specific business domain models may be linked to an appropriate high-level domain.

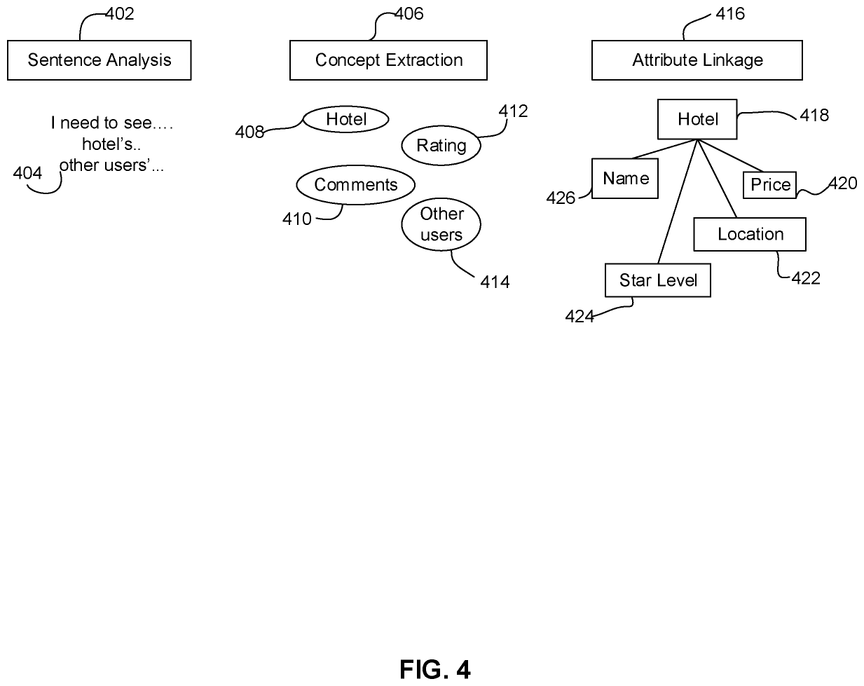

Referring now to FIG. 4, a block diagram showing an exemplary requirement analysis process using an NLP-based business domain modeling operation is depicted according to at least one embodiment. The NLP-based domain modeling program 110A, 110B may perform sentence analysis 402 by analyzing a sentence 404, “I need to see . . . hotel's . . . other users's . . . ”. The NLP-based domain modeling program 110A, 110B may determine, for example, words such as “I”, “need to”, and “see” are irrelevant as they may not imply any business-related concepts based on the analysis performed by a previously trained NLP technology or manually pre-configured irrelevant words list. The NLP-based domain modeling program 110A, 110B may then perform concept extraction 406. The NLP-based domain modeling program 110A, 110B may extract business-related concepts such as “Hotel” 408, “Rating” 412, “Comments” 410 and “Other users” 414 from the sentence “I need to see . . . hotel's . . . other users's . . . ” 404. The NLP-based domain modeling program 110A, 110B may create attribute linkages 416. The NLP-based domain modeling program 110A, 110B may determine attributes, “Hotel” 418, “Name” 426, “Price” 420, “Location” 422 and “Star Level” 424 from the extracted concepts, “Rating” 412 and “Comments” 410. In one other embodiment, the NLP-based domain modeling program 110A, 110B may disregard “other users” 414 as the NLP-based domain modeling program 110A, 110B may not be able to find any relevant attributes from the database 312 or the database 314.

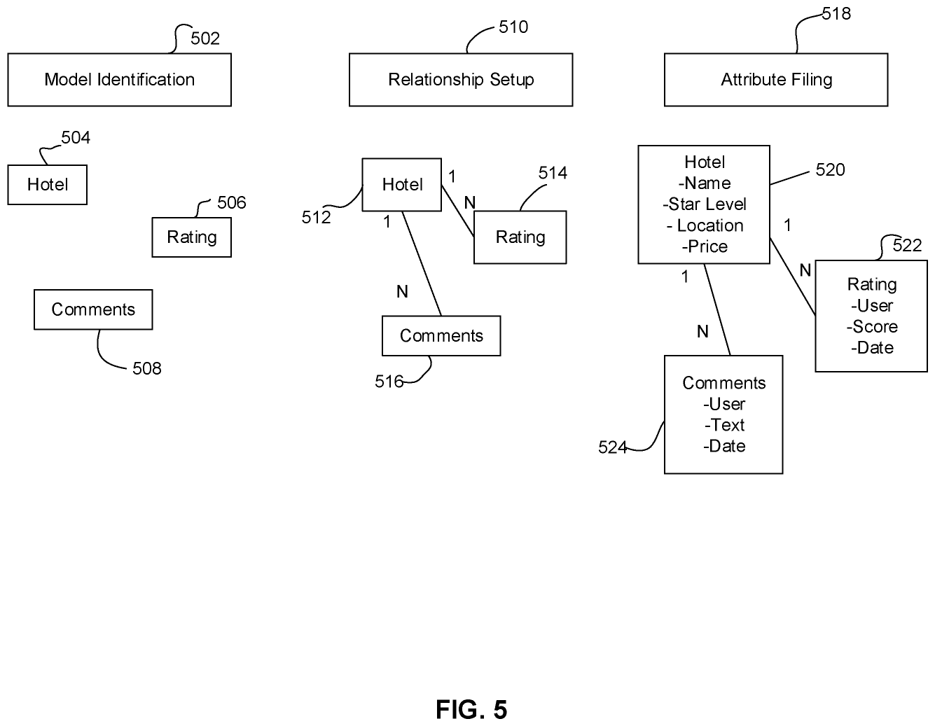

Referring now to FIG. 5, a block diagram showing an exemplary domain model building process using an NLP-based business domain modeling operation is depicted according to at least one embodiment. The NLP-based domain modeling program 110A, 110B may include a model identification component 502 and identify three models, “Hotel” 504, “Rating” 506, and “Comments” 508. As previously described, the NLP-based domain modeling program 110A, 110B may identify only these three models and none for the concept, “Other users” 414 as there are no relevant attributes extractable from the database 312 or the database 314. The NLP-based domain modeling program 110A, 110B may include a relationship setup component 510 and may select “Hotel” 512 as the main motel and connect “Rating” 514 and “Comments” 516 to “Hotel” 512. “Hotel” 512 may have a 1:N ratio relationship with “Rating” 514 and “Comments” 516. In other words, “Hotel” 512 may have more than 1 “Rating” models connected to “Hotel” 512. The NLP-based domain modeling program 110A, 110B may include an attribute filing component 518 and may fill each model with relevant attributes that were extracted by other components in previous steps or such relevant attributes saved in the database 312 or the database 314. The NLP-based domain modeling program 110A, 110B may attach attributes data, such as “name”, “star level”, “location” and “price” to Model 520. Model 522 illustrates that the NLP-based domain modeling program 110A, 110B may attach attributes data such as “user”, “score” and “date”. The model 524 now may include the attached attributes data, such as “user”, “text” and “date”.

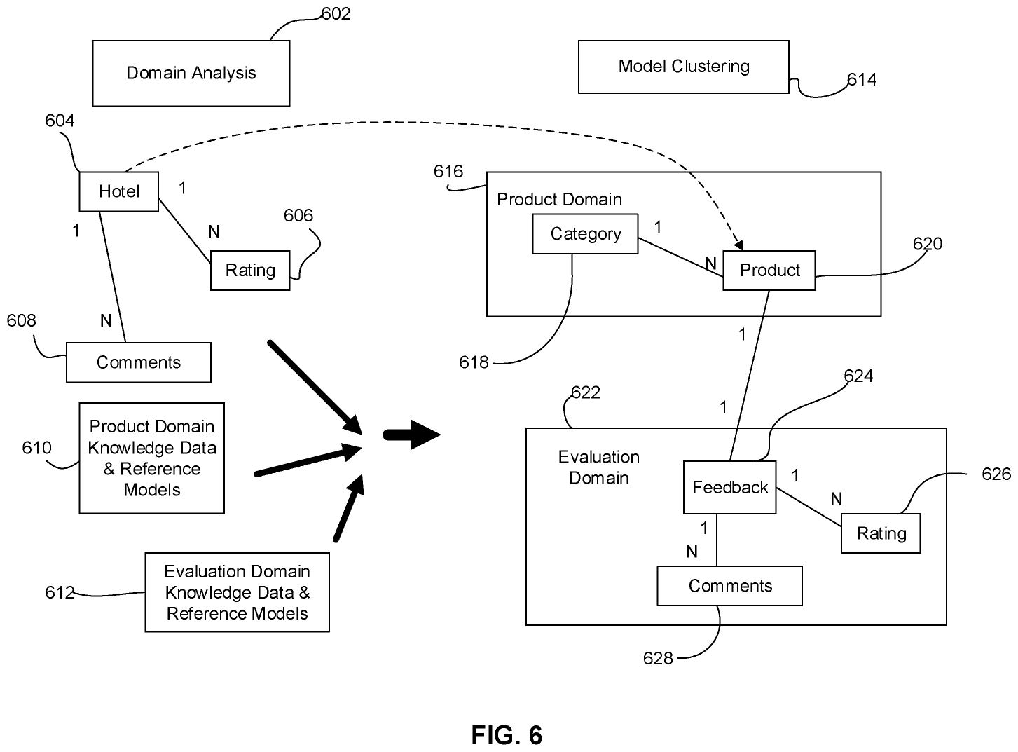

Referring now to FIG. 6, a block diagram showing an exemplary model refine and clustering process using an NLP-based business domain modeling operation is depicted according to at least one embodiment. According to one embodiment, the NLP-based domain modeling program 110A, 110B may include components such as domain analysis 602 and model clustering 614. In this illustration, the NLP-based domain modeling program 110A, 110B has a main model “Hotel” 604 and two other models, “Rating” 606 and “Comments” 608 connected to “Hotel” 604. The NLP-based domain modeling program 110A, 110B may analyze product domain knowledge data and reference models 610 and evaluation domain knowledge data and reference models 612 received from the knowledge database 314 to analyze and determine relevant domains. For example, the NLP-based domain modeling program 110A, 110B may select a product domain 616 and an evaluation domain 622 as correlated domains. The product domain 616 may include models, “Category” 618 and “Product” 620. The evaluation domain 622 may include models, “Feedback” 624, “Rating” 626 and “Comments” 628. The model clustering component 614 may then cluster the model “Hotel” 604 into the model “Product” 620. The model clustering component 614 may also refine and generalize the domains by connecting the evaluation domain 622 to the product domain 616 to represent they have 1:1 relationship.

It may be appreciated that FIGS. 2-6 provide only an illustration of one implementation and do not imply any limitations with regard to how different embodiments may be implemented. Many modifications to the depicted environments may be made based on design and implementation requirements. For example, in at least one embodiment, the NLP-based domain modeling program 110A, 110B may parse documents, extract concepts and create trees or graphs to store the data in a document data store.

FIG. 7 is a block diagram 700 of internal and external components of the client computing device 102 and the server 112 depicted in FIG. 1 in accordance with an embodiment of the present invention. It should be appreciated that FIG. 7 provides only an illustration of one implementation and does not imply any limitations with regard to the environments in which different embodiments may be implemented. Many modifications to the depicted environments may be made based on design and implementation requirements.

The data processing system 702, 704 is representative of any electronic device capable of executing machine-readable program instructions. The data processing system 702, 704 may be representative of a smart phone, a computer system, PDA, or other electronic devices. Examples of computing systems, environments, and/or configurations that may represented by the data processing system 702, 704 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 702 a,b and external components 704 a,b illustrated in FIG. 7. Each of the sets of internal components 702 include one or more processors 720, one or more computer-readable RAMs 722, and one or more computer-readable ROMs 724 on one or more buses 726, and one or more operating systems 728 and one or more computer-readable tangible storage devices 730. The one or more operating systems 728, the software program 708 and the NLP-based domain modeling program 110A in the client computing device 102 and the NLP-based domain modeling program 110B in the server 112 are stored on one or more of the respective computer-readable tangible storage devices 730 for execution by one or more of the respective processors 720 via one or more of the respective RAMs 722 (which typically include cache memory). In the embodiment illustrated in FIG. 7, each of the computer-readable tangible storage devices 730 is a magnetic disk storage device of an internal hard drive. Alternatively, each of the computer-readable tangible storage devices 730 is a semiconductor storage device such as ROM 724, EPROM, flash memory or any other computer-readable tangible storage device that can store a computer program and digital information.

Each set of internal components 702 a,b also includes an R/W drive or interface 732 to read from and write to one or more portable computer-readable tangible storage devices 738 such as a CD-ROM, DVD, memory stick, magnetic tape, magnetic disk, optical disk or semiconductor storage device. A software program, such as the NLP-based domain modeling program 110A, 110B can be stored on one or more of the respective portable computer-readable tangible storage devices 738, read via the respective R/W drive or interface 732 and loaded into the respective hard drive 730.

Each set of internal components 702 a,b also includes network adapters or interfaces 736 such as a TCP/IP adapter cards, wireless Wi-Fi interface cards, or 3G or 4G wireless interface cards or other wired or wireless communication links. The software program 108 and the NLP-based domain modeling program 110A in the client computing device 102 and the NLP-based domain modeling program 110B in the server 112 can be downloaded to the client computing device 102 and the server 112 from an external computer via a network (for example, the Internet, a local area network or other, wide area network) and respective network adapters or interfaces 736. From the network adapters or interfaces 736, the software program 108 and the NLP-based domain modeling program 110A in the client computing device 102 and the NLP-based domain modeling program 110B in the server 112 are loaded into the respective hard drive 730. The network may comprise copper wires, optical fibers, wireless transmission, routers, firewalls, switches, gateway computers and/or edge servers.

Each of the sets of external components 704 a,b can include a computer display monitor 744, a keyboard 742, and a computer mouse 734. External components 704 a,b can also include touch screens, virtual keyboards, touch pads, pointing devices, and other human interface devices. Each of the sets of internal components 702 a,b also includes device drivers 740 to interface to computer display monitor 744, keyboard 742, and computer mouse 734. The device drivers 740, R/W drive or interface 732, and network adapter or interface 736 comprise hardware and software (stored in storage device 730 and/or ROM 724).

It is understood in advance that although this disclosure includes a detailed description on cloud computing, implementation of the teachings recited herein is not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is a service oriented with a focus on statelessness, low coupling, modularity, and semantic interoperability. At the heart of cloud computing is an infrastructure comprising a network of interconnected nodes.

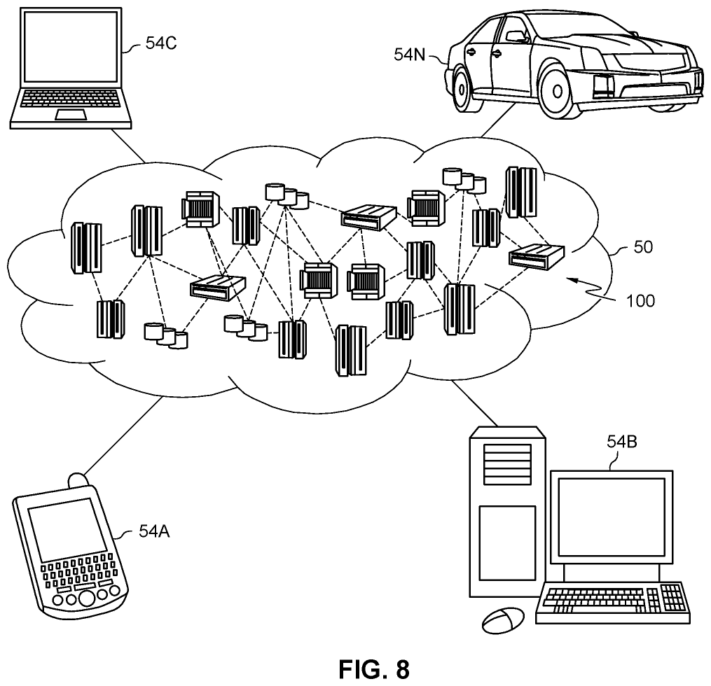

Referring now to FIG. 8, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 8 are intended to be illustrative only and that computing nodes 100 and cloud computing environment 50 can communicate with any type of computerized device over any type of network and/or network addressable connection (e.g., using a web browser).

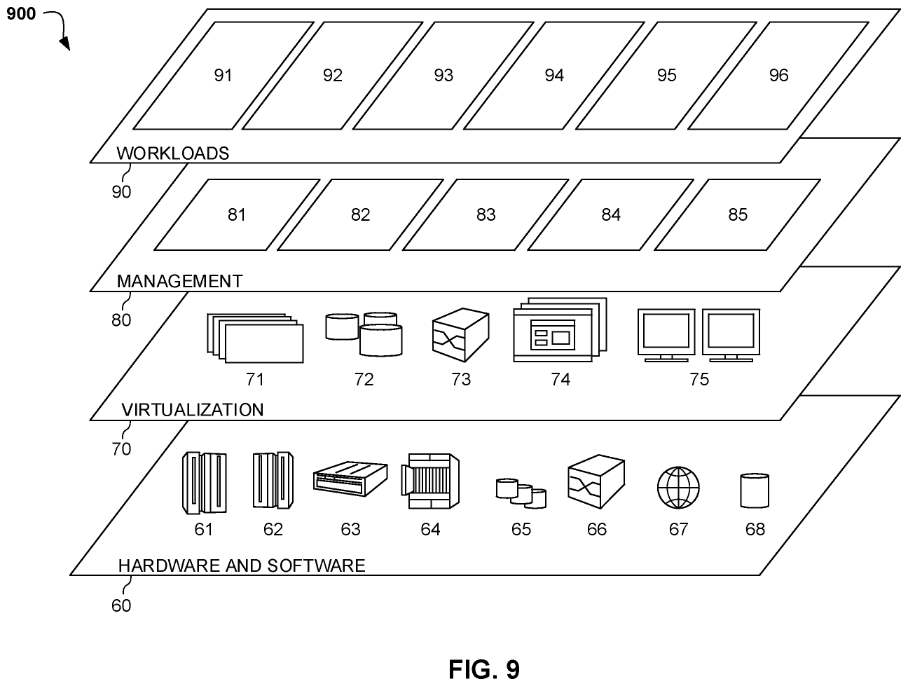

Referring now to FIG. 9, a set of functional abstraction layers 900 provided by cloud computing environment 50 is shown. It should be understood in advance that the components, layers, and functions shown in FIG. 9 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and NLP-based domain modeling 96. NLP-based domain modeling 96 may relate to taking business requirements data as input and generating domain models as output.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for NLP-based domain modeling, the method comprising:
receiving, by a processor, a plurality of documents related to business requirements;
parsing the received documents to extract business concepts based on sentence analysis utilizing an NLP technology;
generating domain models based on the extracted business concepts; and
clustering the generated domain models into specific domains.

2. The method of claim 1, further comprising:
determining relationships between the generated models; and
linking models based on the determined relationships.

3. The method of claim 1, further comprising:
determining relevant attributes based on the parsed documents; and
attaching the determined relevant attributes to each generated model.

4. The method of claim 1, further comprising:
analyzing potential business domains based on relationships among the generated models; and
refining the business domains using references from knowledge data.

5. The method of claim 1, further comprising:
removing invalid models from the generated domain models.

6. The method of claim 1, further comprising:
generating trees or graphs based on the extracted concepts; and
saving the trees or the graphs in a database.

7. The method of claim 1, wherein the plurality of the documents related to the business requirements are received from social media sites or user uploaded documents.

8. A computer system for NLP-based domain modeling, the computer system comprising:
one or more processors, one or more computer-readable memories, one or more computer-readable tangible storage media, and program instructions stored on at least one of the one or more tangible storage media for execution by at least one of the one or more processors via at least one of the one or more memories, wherein the computer system is capable of performing a method comprising:
receiving, by a processor, a plurality of documents related to business requirements;
parsing the received documents to extract business concepts based on sentence analysis utilizing an NLP technology;
generating domain models based on the extracted business concepts; and
clustering the generated domain models into specific domains.

9. The computer system of claim 8, further comprising:
determining relationships between the generated models; and
linking models based on the determined relationships.

10. The computer system of claim 8, further comprising:
determining relevant attributes based on the parsed documents; and
attaching the determined relevant attributes to each generated model.

11. The computer system of claim 8, further comprising:
analyzing potential business domains based on relationships among the generated models; and
refining the business domains using references from knowledge data.

12. The computer system of claim 8, further comprising:
removing invalid models from the generated domain models.

13. The computer system of claim 8, further comprising:
generating trees or graphs based on the extracted concepts; and
saving the trees or the graphs in a database.

14. The computer system of claim 8, wherein the plurality of the documents related to the business requirements are received from social media sites or user uploaded documents.

15. A computer program product for NLP-based domain modeling, the computer program product comprising:
one or more computer-readable tangible storage media and program instructions stored on at least one of the one or more tangible storage media, the program instructions executable by a processor of a computer to perform a method, the method comprising:
receiving, by a processor, a plurality of documents related to business requirements;
parsing the received documents to extract business concepts based on sentence analysis utilizing an NLP technology;
generating domain models based on the extracted business concepts; and
clustering the generated domain models into specific domains.

16. The computer program product of claim 15, further comprising:
determining relationships between the generated models; and
linking models based on the determined relationships.

17. The computer program product of claim 15, further comprising:
determining relevant attributes based on the parsed documents; and
attaching the determined relevant attributes to each generated model.

18. The computer program product of claim 15, further comprising:
analyzing potential business domains based on relationships among the generated models; and
refining the business domains using references from knowledge data.

19. The computer program product of claim 15, further comprising:
removing invalid models from the generated domain models.

20. The computer program product of claim 15, further comprising:
generating trees or graphs based on the extracted concepts; and
saving the trees or the graphs in a database.
